(19) United States
(12) Patent Application Publication
(10) Pub. No.: US 2013/0061146 A1
(43) Pub. Date: Mar. 7, 2013

(54) SYSTEM AND METHOD FOR DEVELOPING ARCHITECTURAL DESIGNS

(71) Applicant: Shaun K. Kirby, Pasadena, CA (US)

(72) Inventor: Shaun K. Kirby, Pasadena, CA (US)

(73) Assignee: Cisco Technology, Inc.

(21) Appl. No.: 13/226,815

(22) Filed: Sep. 7, 2011

(51) Int. Cl. G06F 3/048; G06F 15/16

(52) U.S. Cl. 715/738

(57) ABSTRACT

An apparatus is provided in one example embodiment and includes a memory element; a processor coupled to the memory element; an architecture library configured for providing a plurality of identifiers for a plurality of architecture components in a pattern library; an architecture rules engine configured for providing a plurality of rules associated with the architecture components being provisioned into one or more architectural designs; an interview engine configured for providing a plurality of interview questions for soliciting information associated with a particular architectural design, where a plurality of responses associated with the interview questions can be received by the apparatus; and a visualization engine configured for generating an output presentation for the particular architectural design based on the responses.

### TECHNICAL FIELD

This disclosure relates in general to architectural management and, more particularly, to a system and a method for developing architectural designs.

### BACKGROUND

Technology vendors strive to differentiate themselves in a competitive landscape, where technology commoditization is in a constant state of acceleration. Additionally, electronic and network architectural designs have become holistic: accounting for all aspects of a business segment for which an architecture would be implemented. The ability to persuade executives and other decision makers requires a keen understanding of a customer's business needs, along with the ability to link business needs to technology enablers. Any presentation output to be provided to the customer (which may take the form of visualizations) should be thorough, clear, intuitive, engaging, and convincing.

Few sales professionals have the necessary time to develop an in-depth understanding of a customer's business, nor do most sales professionals possess the technology proficiency/aptitude to proffer a complete architecture story. Moreover, different business teams (within a single organization) routinely develop similar architectures for electronics and networks to meet commonly occurring business needs. These business needs often arise across different industries. When similar architectures are independently developed, efforts from the workforce are essentially being duplicated unnecessarily. Amassed knowledge is not being leveraged, as the wheel continues to be reinvented by professionals working in the same organization. Thus, providing an architectural development paradigm (with the capacity to leverage previously attained knowledge and with the intention of offering a unifying message) presents a significant challenge to developers, manufacturers, and executives alike.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram illustrating an example embodiment of a communication system according to the present disclosure;

FIG. 1B is a simplified flowchart illustrating example activities that may be associated with an embodiment of the communication system;

FIG. 2A is a simplified screenshot that illustrates potential capabilities and features that may be associated with an embodiment of the communication system;

FIG. 2B is another simplified screenshot that illustrates potential capabilities and features that may be associated with an embodiment of the communication system; and

FIG. 3 is another simplified screenshot that illustrates potential capabilities and features that may be associated with an embodiment of the communication system.

### DETAILED DESCRIPTION OF EXAMPLE EMBODIMENTS

### Overview

An apparatus is provided in one example embodiment and includes a memory element; a processor coupled to the memory element; and an architecture pattern library configured for providing a plurality of identifiers for a plurality of architecture components in a pattern library. The identifiers can be any suitable object, name, text, graphic, icon, etc. The apparatus may also include an architecture rules engine configured for providing a plurality of rules associated with the architecture components being provisioned into one or more architectural designs. The rules can be part of an algorithm, a guide, a database, a repository, a dropdown menu, or any other suitable element. The apparatus can further include an interview engine configured for providing a plurality of interview questions for requesting information associated with a particular architectural design, where a plurality of responses associated with the interview questions can be received by the apparatus. The apparatus can also include a visualization engine configured for generating an output presentation for the particular architectural design based on the responses.

In particular implementations, at least one of the rules designates that a presence of a first one of the components indicates that a second one of the components should be provided in conjunction with the first component. In other instances, at least one of the rules designates that a certain capability solicited through the interview questions can be met by a particular product. Note that a certain one of the responses to the interview questions can trigger a different one of the questions being subsequently asked about the particular architectural design.

The pattern library can include relationship data associated with each of the architecture components. Each of the architecture components has an extensible set of properties that include an architecture component name, an architecture component type, and an architecture component description. The pattern library can also include a plurality of reference architectures to be used as a basis for creating one or more subsequent architectural designs.

The output presentation can include any number of visual elements for illustrating information associated with the particular architectural design. For example, the output presentation may include a slide, a graphic image, or a wall poster. The output presentation can be rendered in a web-based format to an endpoint associated with providing the responses to the interview questions.

### EXAMPLE EMBODIMENTS

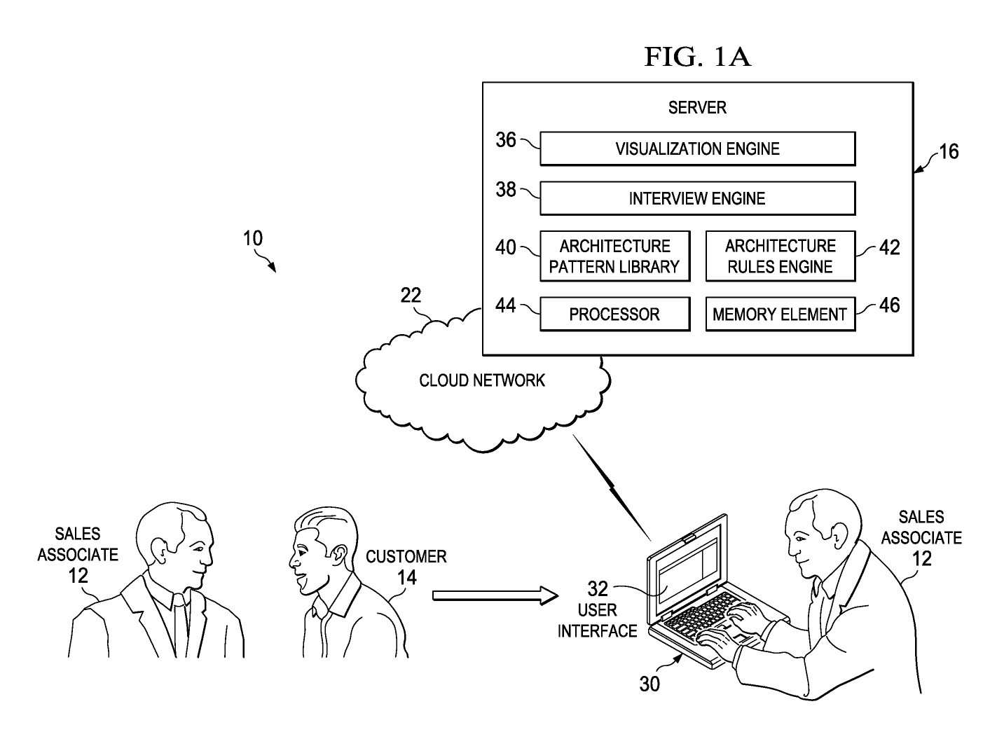

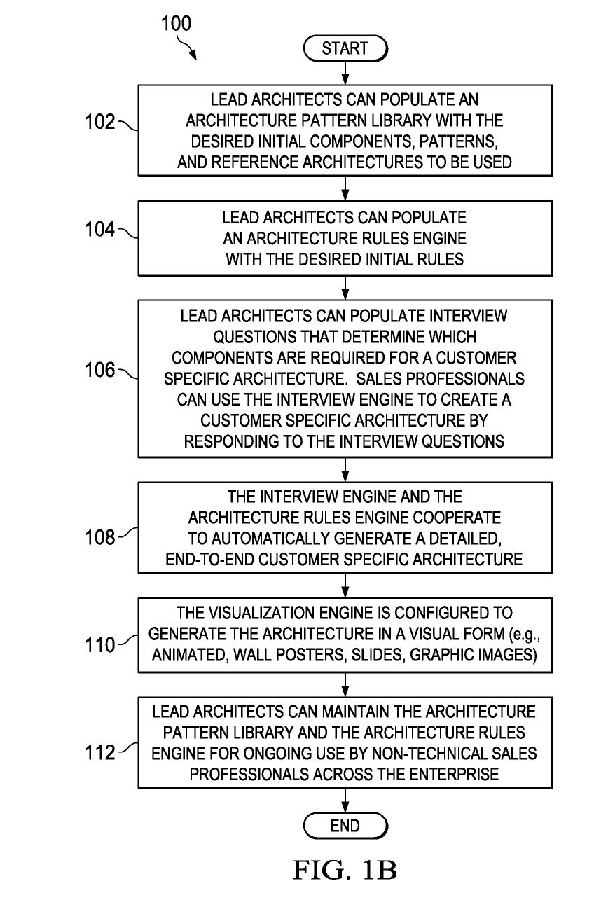

Turning to FIG. 1A, FIG. 1A is a simplified block diagram of a communication system 10 configured for scaling and unifying architecture sales in accordance with one example embodiment of the present disclosure. FIG. 1A includes a sales associate 12, a customer 14, and a server 16. In this particular example, an initial meeting can occur between sales associate 12 and customer 14, where this meeting results in sales associate 12 operating an endpoint 30, which has a user interface 32 for interacting with server 16. For example, sales associate 12 can initially meet with customer 14 in order to have a consultation, where the information provided by those discussions can be used as a basis for sales associate 12 to interact with server 16, as detailed below.

FIG. 1A also includes a cloud network 22 in which server 16 is being provisioned in this particular example. Server 16 may include a visualization engine 36, an interview engine 38, an architecture pattern library 40, an architecture rules engine 42, a processor 44, and a memory element 46. The elements of FIG. 1A may couple to one another through any suitable connection (wired or wireless), which provides a viable pathway for network communications. Additionally, any one or more of the elements of FIG. 1A may be combined or removed from the architecture based on particular configuration needs.

Note that the capabilities, nuances, and features of system 10 can be best understood in the context of a series of example business scenarios. Consider a first example in which sales associate 12 has met with customer 14 in order to understand his client's business objectives, to ascertain infrastructure needs of the client, to identify strategic business opportunities, etc. This particular client is a vice president of a technology company, which is engaged in developing energy management systems in residential environments. The energy management systems are somewhat complex in that they are being controlled by strategically placed servers, switches, and home energy controllers (HECs). This vice president has certain business concerns (e.g., often termed ‘care abouts’) that relate to his customer base. These concerns should be addressed in order to offer an enjoyable experience for his residential customers, who (in this particular example) enroll in a subscription service for energy conservation.

Sales associate 12 (in the context of his customer relationship responsibilities to his own company) seeks to fully understand the needs of his customer 14 and, subsequently, deliver a precise architecture that satisfies these needs. Additionally, sales associate 12 strives to strengthen his relationship with this client in hopes of engendering repeat business opportunities. One important tenet in these activities lies in intelligently analyzing the critical input information being communicated to sales associate 12 by his customer 14. Ultimately, sales associate 12 would like to offer a persuasive architecture story (inclusive of visualizations) that systematically addresses and satisfies the needs of his client.

In this particular technology scenario, sales associate 12 has only a surface level understanding of energy management technologies and, further, has limited knowledge about how network technologies function in order to achieve the energy management activities, which are provided by his client's company. In this scenario, it is imperative that sales associate 12 delivers an architecture that fulfills the needs of his client and that meets the outlined business objectives, which were specified in the initial consultation.

In regards to timing, the delivery of this architecture is critical to the client. For example, ramp-up activities, knowledge transfers, etc. should be kept to a minimum. In many cases, lag time results from learning technology, redoing research, reengineering architectures, or changing the fundamental issues trying to be solved by the developed architecture. It should also be noted that at various points during the sales cycle, new issues can present themselves to sales associate 12.

In this example scenario, sales associate 12 is employed by a large company, which affords him the benefit of accessing information already attained by his colleagues. Indeed, some of these colleagues are experts, who have developed wisdom in certain technological areas. In addition, there will be certain employees that have information that is more current for some technology fields. For example, certain employees may have intimate knowledge about their latest product release involving energy management. Sales associate 12 should account for the organically developed information resident in his own company. Not only does this sharing help his customer 14, if sales associate 12 does not access this information, then he runs the risk of communicating inconsistent messaging across his own enterprise. When this inconsistency is prevalent, it diminishes the unity of corporate messaging, inhibits the establishment of architecture eminence in the marketplace, and generally undermines a company's credibility.

In accordance with the teachings of the present disclosure, communication system 10 offers a platform that can empower non-technical sales professionals to create a compelling/detailed technology architecture without the assistance of an architect, engineer, technologist, etc. Through an extensible repository of architecture patterns and rules, communication system 10 is configured to scale the expertise of a few architects across an entire enterprise. Additionally, the platform can enable organizations to achieve consistent architecture messaging that includes current business trends and that includes the latest technology products.

In operation, the platform can be accessed by sales associate 12 (e.g., over a network connection) in order to generate technology architectures with engaging animations. These operations can be performed quickly and efficiently by leveraging proven (and continuously evolving) architecture patterns and a rules library: both of which may be resident in server 16. For example, architectural designs can be created by sales associate 12 through answering a simple set of questions associated with business objectives. (The questions can take any format (multiple choice, yes/no, graphical, written response requested, matching, voice activation, etc.) Note that the architectures created by different teams of the same company can have a consistent appearance and theme, which supports congruency in corporate architectural messaging. This unification of messaging also engenders an expedition of the architecture sell to customer 14.

In certain implementations, the platform of communication system 10 can include a multitude of layers (e.g., business, capabilities, data, applications, infrastructure, etc.). Each layer can have a set of components for which rules are provisioned. For example, if a certain business need is present, then a certain capability can be matched to that business need. The rules can then be compounded by indicating that if a certain capability is present, then a certain application and/or a certain infrastructure should be matched against this capability. Hence, by simply selecting a given business objective (i.e., a care about), technology recommendations and capabilities can be offered to customer 14. The architecture of communication system 10 is meant to simplify the relevant architecture diagrams that take considerable time to generate.

In practice, communication system 10 can arm sales professionals with a number of valuable tools for identifying and articulating sales opportunities. For example, the platform can provide a visual identification of recommended capabilities and products that may be absent from the customer's current business line. This identification can be achieved by comparing the customer's baseline architecture to products and technologies (currently available in the marketplace) that are populated in server 16. Note that communication system 10 is also amenable to identifying additional customer solutions, where a particular component (e.g., a strategic objective, capability, or technology product) has played a role.

Because the creation of the architectural design does not require assistance from an architect or technologist, organizations can use communication system 10 to scale their architecture capability quickly across the organization. In these scenarios, architects can focus on the essence of their craft by populating the platform with the fundamental architecture patterns and rules from which myriad solution specific architectures are derived.

Hence, business users with no technology background or with limited architecture tool knowledge can readily create compelling end-to-end business and technology architectures through an intuitive, extensible, guided interview process. This interview process can adhere to a question and answer format, which guides sales associate 12 through the framework. The interview process can be oriented for a person having limited expertise, where minimal (or perhaps no) training would be necessary to use the tool. Furthermore, this interviewing paradigm can be systematically maintained with current business trends, the latest architecture patterns, and up-to-date technology products.

In practice, communication system 10 supplies a missing link between strategic business objectives and the required technologies to satisfy those business objectives. This important link can take the form of architecture rules describing which capabilities are required to meet an organization's strategic business objectives and, in turn, which technologies support the capabilities. Separately, the resultant (architecture output) produced by communication system 10 is precise: reflecting a resolution of the issues raised during the interview process.

In addition, the output can link specific technology to the identified business needs and, further, render visualizations suitable for immediate selling opportunities by sales associate 12. Essentially, the resultant architecture story is presented in an animated, interactive, visual format, which includes the requisite details at granular levels. For example, the resultant output may include the illustration of specific vendor products, exact technology integrations, etc. Thus, communication system 10 accomplishes targeted objectives by outlining the story of how specific technology can empower a particular business segment. Additionally, the platform of communication system 10 offers an approach that identifies the technology required to achieve strategic objectives and, further, shows explicitly how each technology component can support the business.

Before turning to some of the additional operations of communication system 10, a brief discussion is provided about some of the infrastructure of FIG. 1A. Architecture pattern library 40 is a repository (e.g., a memory) that stores architecture components and their relationships. Each of the components can have an extensible set of properties, including name, type, description, parent, etc. Complex architecture patterns (such as the synchronous interaction for collaboration pattern) can be described simply and elegantly through this paradigm, where architecture pattern library 40 can be updated or extended by adding or modifying the properties of the populated components.

The components and patterns of architecture pattern library 40 can be used to build architectures, in which they take on additional, architecture-specific properties. Architecture pattern library 40 can also contain complete reference architectures (collections of patterns), which can be used as the starting point for customer specific architectures. Note that the term components as being used here can include software components, hardware components, electronic circuitry, electronic tools, infrastructure, larger network configurations, or any other suitable component to be used in the context of developing an architectural design.

Architecture rules engine 42 is a repository (e.g., a memory) of the rules governing how architecture components are assembled into architectures. For example, one type of rule is the dependence of one component on another (e.g., a specific capability that requires a particular technology product). This rule can be implemented by establishing a dependency from a component with type=capability to a component with type=technology product. In operation, a small set of simple rules can give rise to a myriad of complex architectures that outline an architectural story. The architectural story can specify how technology supports business goals from end-to-end. The architectural story can also establish the capabilities required for the business objectives and, further, identify the technologies required to enable the capabilities.

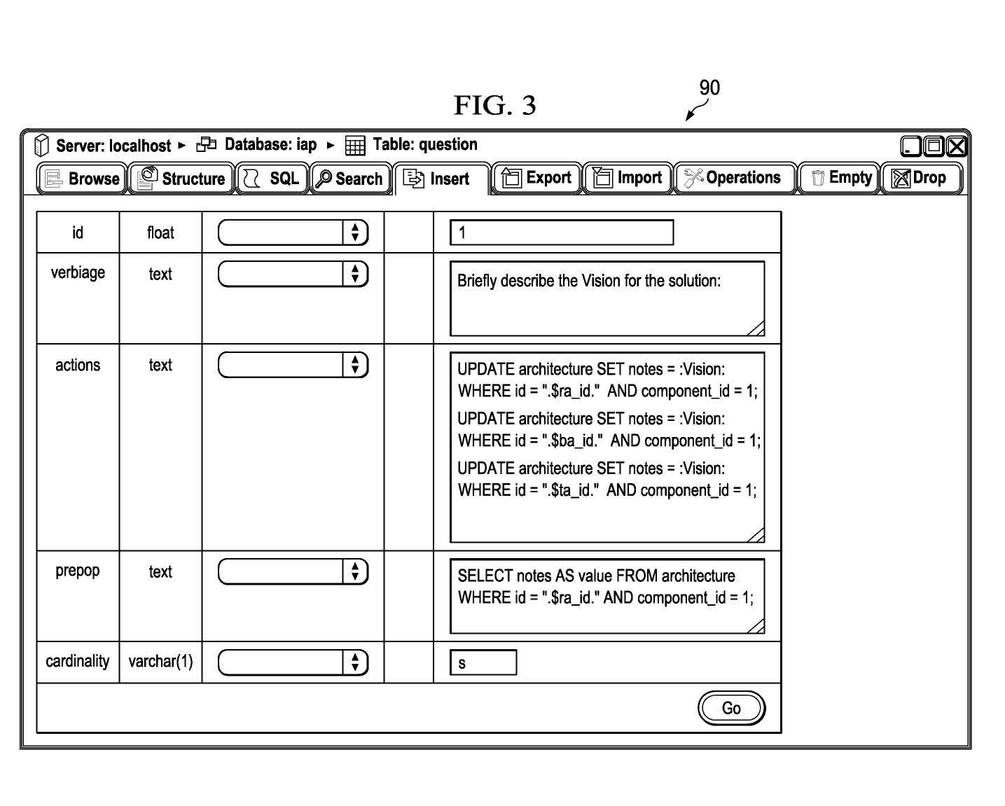

Interview engine 38 can be configured to present interview questions to any given user. Additionally, interview engine 38 can be interactive such that it can take actions based on the user's responses. The questions and actions can be specified in a repository using an extensible, standards-based scripting language. In one particular model, the questions are implemented in a memory element such as a database. Note that one example interview engine 38 instantiation is provided in FIG. 3. In that particular example, the verbiage attribute contains the interview question or request that is displayed to the user. The cardinality (in this example, ‘s’ for single) determines the number of input fields for display. The prepop attribute contains instructions for what (if anything) to pre-populate in the input field(s), and the actions attribute contains the script with instructions for which actions to take once the user has provided input.

In this example, the variable :Vision: (bracketed by colons) represents the contents of the input field (e.g., the data that the user has entered). On completion (when the user clicks to the next question), the actions are executed, in this case, capturing input information into architecture components to be instantiated into the architecture being created. Interview questions can easily be added, removed, or modified using the repository such that the platform is dynamic: evolving to meet the changing needs for architecture enabled sales. Note that the questions can systematically trigger questions that are more specific. The information gathered through the interview questions, coupled with the information embodied in the architecture pattern library and rules, is sufficient to generate complete, detailed, end-to-end business and technology architectures for any desired customer solution or sales opportunity.

Visualization engine 36 is configured to provide a visualized resultant based on the received input. Stated in different terms, once the necessary architecture patterns and components and their instantiation-specific information have been determined through the interview input and through the rules, the resultant architecture can be generated in a visualized format. This would provide a compelling, standardized, interactive, animated presentation for sales associate 12 to use immediately in interacting with his customer 14.

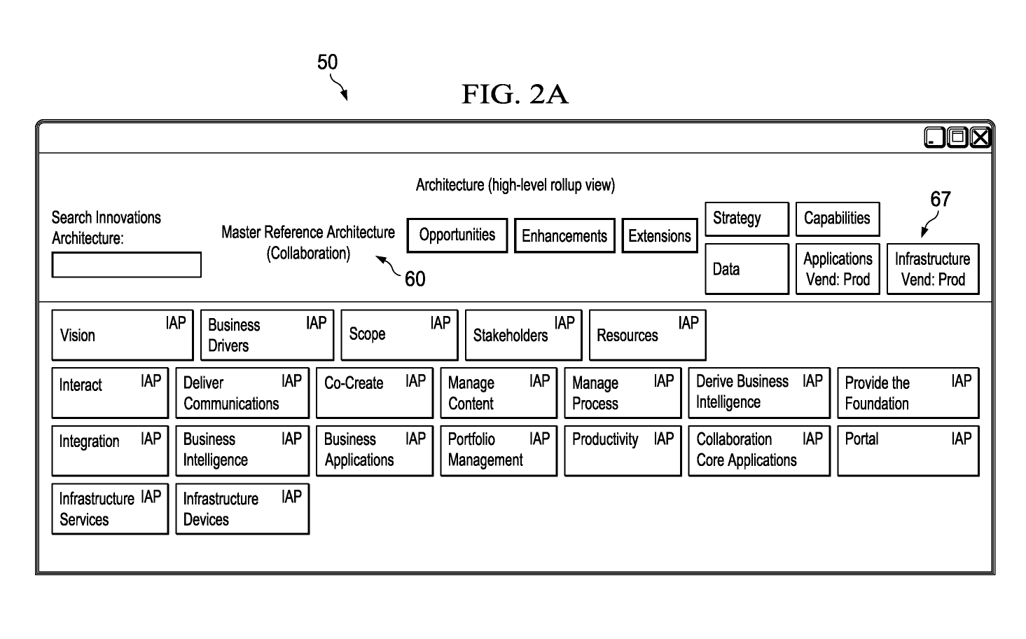

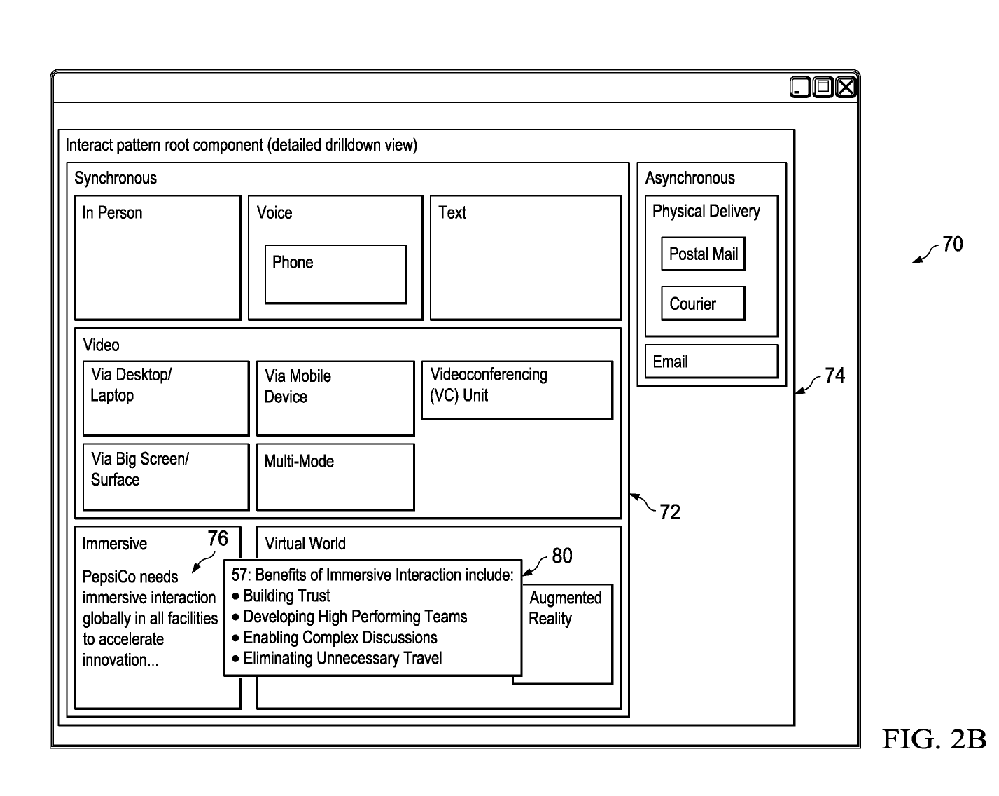

In operation, visualization engine 36 can provide the visualized output by rendering the business and technology architecture in a web-based format. The user has the option to drilldown to more specific options, or to rollup certain views to display different levels of detail (i.e., a more top-level view). (Note that a high-level rollup view is illustrated by FIG. 2A, and a drilldown view is illustrated by FIG. 2B.) The decision for displaying certain levels of detail can be based on different audiences to which the sales associate would be presenting. Additionally, the platform can allow the sales associate to examine new opportunities by highlighting recommended components within server 16. The sales associate can also customize the architecture (if necessary) by dragging/dropping components or groups of components (patterns), and by changing appearance attributes such as color or texture (e.g., to indicate implementation phasing, or to draw special attention to a component, etc.).

Server 16 is a network element that may be provisioned at any appropriate location in the network. The elements of server 16 (e.g., interview engine 38, visualization engine 36, etc.) can readily be part of a server configuration in certain embodiments of the present disclosure, or be part of any suitable network element that facilitates or otherwise helps coordinate the architectural design operations, as explained herein. As used herein in this Specification, the term ‘network element’ is meant to encompass network appliances, servers, processors, modules, or any other suitable device, proprietary component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

Note that each of visualization engine 36, interview engine 38, architecture pattern library 40, and/or architecture rules engine 42 can be provisioned with their own dedicated processors and memory elements (not shown), or alternatively the processors and memory elements may be shared by these elements. In the particular implementation of FIG. 1A, server 16 includes software (e.g., as part of visualization engine 36, interview engine 38, architecture pattern library 40, architecture rules engine 42) to achieve the architectural design operations, as outlined herein in this document. In other embodiments, this feature may be provided externally to any of the aforementioned elements, or included in some other network element to achieve this intended functionality.

Alternatively, several elements may include software (or reciprocating software) that can coordinate in order to achieve the operations, as outlined herein. For example, endpoint 30 may include user interface 32, which may include suitable algorithms, hardware, software, components, modules, interfaces, or objects that facilitate the architectural design operations discussed herein. Hence, endpoint 30 and server 16 may coordinate their activities in order to accomplish the activities discussed herein.

Endpoint 30 can include user interface 32, which may be configured to access the capabilities associated with server 16. In a particular embodiment, a simple software download can provision appropriate software in endpoint 30 for conducting the architectural design activities discussed herein. For example, an instance of the components of server 16 can be replicated in (and provided to) endpoint 30. This can include an instance of user interface 32 being provisioned in endpoint 30. In a general sense, many of the architectural designs can be performed locally at endpoint 30. In other instances, where more complex processing occurs, the activities discussed herein can be facilitated by user interface 32, where server 16 would be used to execute more robust or comprehensive processing activities.

The term ‘endpoint’ is a broad term representative of devices used to initiate a communication such as a laptop, a mobile telephone, a personal digital assistant (PDA), a Cius tablet, an iPhone, an iPad, an Android device, any other type of smartphone, a desktop personal computer, or any other device, component, element, or object capable of initiating or exchanging data within communication system 10. Endpoint 30 may also be inclusive of a suitable interface to an end user, such as a microphone, a keyboard, a webcam, etc. Data, as used herein, refers to any type of video, numeric, voice, or script data, or any type of source or object code, or any other suitable information in any appropriate format that may be communicated from one point to another.

Cloud network 22 represents a series of points or nodes of interconnected communication paths for receiving and transmitting packets of information that propagate through communication system 10. Cloud network 22 can offer a communicative interface between endpoint 30 and other network elements (e.g., server 16), and may be any local area network (LAN), Intranet, extranet, wireless local area network (WLAN), metropolitan area network (MAN), wide area network (WAN), virtual local area network (VLAN), virtual private network (VPN), or any other appropriate architecture or system that facilitates communications in a network environment. Communication system 10 may facilitate or otherwise implement a UDP/IP connection and use a TCP/IP communication protocol in particular embodiments. However, the architecture may alternatively implement any other suitable communication protocol for transmitting and receiving data packets within communication system 10. Cloud network 22 may foster any communications involving services, content, video, voice, applications, or data more generally, as it is exchanged between end users and various network elements. This would include the propagation of enterprise data, which can have an assigned portal for protecting confidential enterprise information.

Turning to FIG. 1B, FIG. 1B is a simplified flowchart 100 illustrating example activities associated with communication system 10. In a first stage (indicated generally at 102), the lead architects of an organization can populate architecture pattern library 40 with the desired initial components, patterns, and reference architectures to be used (e.g., universally in the enterprise). For example, over the course of a company's lifetime, certain products will be developed. The characteristics associated with those products can be input into the architecture pattern library for potential future reference. These products can be linked to existing capabilities, or new capabilities, as discussed below with reference to 104. Additionally, by systematically updating architecture pattern library 40, users of the platform can continue to access the most current capabilities and technologies that could be made available to customer 14. Hence, the architecture of the present disclosure is drawing from its internal wisdom bank (e.g., in the context of leveraging architecture pattern library 40) such that previously acquired information can be readily attained. In this sense, the solution is easily scalable across the enterprise, as any instance of user interface 32 can be used as a gateway for accessing the architectural design capabilities discussed herein.

At 104, architects can populate architecture rules engine 42 with the desired initial rules, which should be adhered to by the architectures themselves. These rules can offer guidance such that the resulting architectures are logical and complete. For example, these rules can offer guidelines for which components or patterns should be present when certain other components are present.

At 106, lead architects can populate interview questions that determine which seed components should be used for a customer specific architecture. The sales professionals can use interview engine 38 to create a customer specific architecture by responding to the interview questions. The responses can be based on the customer's needs, opportunities, etc. For example, after several engagements with a certain client, a number of themes may emerge (e.g., specific objectives or care abouts for particular industries). Hence, a given use case may involve sales associate 12 initially selecting an appropriate library (that may be resident in architecture pattern library 40) such that the platform can make recommendations (based on the library choices), and identify which capabilities are required. Based on certain responses to the interview questions, rules can be invoked. This would allow the initial components to be brought together for the preliminary (starting) architecture. The listing of components can then be brought back to visualization engine 36, as outlined below.

Returning to the flow of FIG. 1B, at 108 interview engine 38 and architecture rules engine 42 automatically generate a detailed, end-to-end customer specific business and technology architecture. At 110, visualization engine 36 is configured to render the architecture. In more formalistic terms, the output can be reflective of a domain decomposition view, where certain boxes can be drawn to represent each of the components. This can include rendering this particular architecture in a compelling, standardized, interactive, animated form, which can be immediately used by sales associate 12. For example, sales associate 12 can present this output to the customer, which can further facilitate sales discussions. Additionally, this output can be used to produce architectural deliverables such as wall posters, slides, or graphic images. At 112, lead architects can maintain architecture pattern library 40 and architecture rules engine 42 for ongoing use by non-technical sales professionals across the enterprise.

FIG. 2A is a simplified high-level rollup view 50 associated with user interface 32. In this particular example, view 50 includes a master reference architecture (collaboration) element 60, along with a number of icons that can be selected in order to process information associated with a particular customer. A number of layers 67 are also included within view 50. Layers 67 (in this particular example) include a strategy icon, a capabilities icon, a data icon, an applications icon (associated with vendor products), and an infrastructure icon (associated with vendor products).

In this example, a search tool is provided in order to identify innovations and architectures provided within the platform. Other icons can include items such as business drivers, scope, stakeholders, resources, content management, process management, integration, business intelligence, business applications, portfolio management, productivity, collaboration core applications, infrastructure services, infrastructure devices, etc.

FIG. 2B is a simplified drilldown view 70 associated with user interface 32. This particular illustration includes an interactive pattern root component 74, which includes synchronous and asynchronous features. Hence, a synchronous component 72 is being illustrated, where this component can include an in person icon, a voice (phone) icon, and a text icon (which may be associated with, for example, e-mail communications). Additionally, a video segment can be provided that includes video via desktop/laptop, a mobile device, a videoconferencing unit, a big-screen/surface, etc. An immersive icon 76 is also provided, along with a virtual world icon, where benefits of immersive interaction are being listed generally at 80.

FIG. 3 is a simplified interview screenshot 90 illustrating possible interview questions that may be used in conjunction with the present disclosure. In general terms, questions can be used in order to request (i.e., to solicit) the business needs and capabilities being sought by customer 14. Interview questions can be specified by verbiage, actions, prepop, and cardinality elements, as detailed herein. Note that any of this formatting can be suitably changed without departing from the broad scope of the present disclosure. Moreover, it is imperative to note that any of the icons, layers, views, elements, etc. included in FIGS. 2A-2B, 3 can be modified, substituted, altered, replaced, removed, or otherwise changed in countless ways without departing from the scope of the present disclosure. Many of these arrangement possibilities can address specific business segment needs, particular industries, or particular configurations.

In regards to the internal structure associated with communication system 10, each endpoint 30 and/or server 16 can include memory elements (as shown in FIG. 1A) for storing information to be used in achieving operations as outlined herein. Additionally, each of these devices may include a processor that can execute software or an algorithm to perform the activities discussed herein. These devices may further keep information in any suitable memory element (e.g., random access memory (RAM), read only memory (ROM), an erasable programmable read only memory (EPROM), application specific integrated circuit (ASIC), etc.), software, hardware, or in any other suitable component, device, element, or object where appropriate and based on particular needs. Any of the memory items discussed herein should be construed as being encompassed within the broad term ‘memory element.’ The information being stored, tracked, or sent by endpoint 30 and/or server 16 could be provided in any database, queue, register, table, cache, repository, control list, or storage structure, all of which can be referenced at any suitable timeframe. Any such storage options are included within the broad term ‘memory element’ as used herein. Similarly, any of the potential processing elements, modules, and machines described herein should be construed as being encompassed within the broad term ‘processor.’ Each of endpoint 30 and server 16 can also include suitable interfaces for receiving, transmitting, and/or otherwise communicating data or information in a network environment.

In one example implementation, endpoint 30 and/or server 16 may include software to achieve, or to foster, the architectural design management operations outlined herein. In other embodiments, these operations may be provided externally to these elements, or included in some other network device to achieve this intended functionality. Alternatively, these elements may include software (or reciprocating software) that can coordinate in order to provide the architectural design management operations, as outlined herein. In still other embodiments, one or all of these devices may include any suitable algorithms, hardware, software, components, modules, interfaces, or objects that facilitate the operations thereof.

Note that in certain example implementations, functions outlined herein may be implemented by logic encoded in one or more tangible media (e.g., embedded logic provided in an ASIC, in digital signal processor (DSP) instructions, software (potentially inclusive of object code and source code) to be executed by a processor, or other similar machine, etc.). In some of these instances, memory elements (as shown in FIG. 1A) can store data used for the operations described herein. This includes the memory elements being able to store code (e.g., software, logic, processor instructions, etc.) that can be executed to carry out the activities described herein. A processor can execute any type of code associated with the data to achieve the operations detailed herein. In one example, the processors (as shown in FIG. 1A) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an EPROM, EEPROM) or an ASIC that includes digital logic, software, code, electronic instructions, or any suitable combination thereof.

Note that with the examples provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of endpoints. It should be appreciated that communication system 10 (and its teachings) are readily scalable and can accommodate a large number of components, as well as more complicated/sophisticated arrangements and configurations. Accordingly, the examples provided should not limit the scope or inhibit the broad teachings of communication system 10 as potentially applied to a myriad of other architectures. Additionally, although described with reference to particular scenarios, where a module is provided within a server, these elements can be provided externally, or consolidated and/or combined in any suitable fashion. In certain instances, certain elements may be provided in a single proprietary module, device, unit, etc.

It is also important to note that the steps in the appended diagrams illustrate only some of the possible signaling scenarios and patterns that may be executed by, or within, communication system 10. Some of these steps may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings provided herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
providing a plurality of identifiers for a plurality of architecture components in a pattern library that is provisioned in a server, which includes a processor;
providing a plurality of rules associated with the architecture components, which are associated with one or more architectural designs;
providing a plurality of interview questions configured to solicit information associated with a particular architectural design, wherein the interview questions are stored in a memory element of the server;
receiving a plurality of responses associated with the interview questions; and
generating an output presentation for the particular architectural design based on the responses.

2. The method of claim 1, wherein at least one of the rules designates that a presence of a first one of the components indicates that a second one of the components should be provided in conjunction with the first component.

3. The method of claim 1, wherein at least one of the rules designates that a certain capability solicited through the interview questions can be met by a particular product.

4. The method of claim 1, wherein a certain one of the responses to the interview questions that is provided to the server prompt a different one of the questions being delivered to solicit additional information about the particular architectural design.

5. The method of claim 1, wherein the output presentation includes a selected one of a group of visual elements for illustrating information associated with the particular architectural design, the group consisting of:
a) a slide;
b) a graphic image; and
c) a wall poster.

6. The method of claim 1, wherein the pattern library includes relationship data associated with each of the architecture components.

7. The method of claim 1, wherein each of the architecture components have an extensible set of properties that include an architecture component name, an architecture component type, and an architecture component description.

8. The method of claim 1, wherein the pattern library includes a plurality of reference architectures to be used as a basis for creating one or more subsequent architectural designs.

9. The method of claim 1, wherein the output presentation is rendered in a web-based format to an endpoint associated with providing the responses to the interview questions.

10. Logic encoded in one or more non-transitory media that includes code for execution and when executed by a processor operable to perform operations comprising:
providing a plurality of identifiers for a plurality of architecture components in a pattern library that is provisioned in a server, which includes the processor;
providing a plurality of rules associated with the architecture components, which are associated with one or more architectural designs;
providing a plurality of interview questions configured to solicit information associated with a particular architectural design, wherein the interview questions are stored in a memory element of the server;
receiving a plurality of responses associated with the interview questions; and
generating an output presentation for the particular architectural design based on the responses.

11. The logic of claim 10, wherein at least one of the rules designates that a presence of a first one of the components indicates that a second one of the components should be provided in conjunction with the first component.

12. The logic of claim 10, wherein at least one of the rules designates that a certain capability solicited through the interview questions can be met by a particular product.

13. The logic of claim 10, wherein a certain one of the responses to the interview questions that is provided to the server prompt a different one of the questions being delivered to solicit additional information about the particular architectural design.

14. The logic of claim 10, wherein the pattern library includes relationship data associated with each of the architecture components, and wherein each of the architecture components have an extensible set of properties that include an architecture component name, an architecture component type, and an architecture component description.

15. The logic of claim 10, wherein the pattern library includes a plurality of reference architectures to be used as a basis for creating one or more subsequent architectural designs.

16. An apparatus, comprising:
a memory element;
a processor coupled to the memory element;
an architecture library configured for providing a plurality of identifiers for a plurality of architecture components in a pattern library;
an architecture rules engine configured for providing a plurality of rules associated with the architecture components being provisioned into one or more architectural designs;
an interview engine configured for providing a plurality of interview questions for soliciting information associated with a particular architectural design, wherein a plurality of responses associated with the interview questions can be received by the apparatus; and
a visualization engine configured for generating an output presentation for the particular architectural design based on the responses.

17. The apparatus of claim 16, wherein at least one of the rules designates that a presence of a first one of the components indicates that a second one of the components should be provided in conjunction with the first component.

18. The apparatus of claim 16, wherein at least one of the rules designates that a certain capability solicited through the interview questions can be met by a particular product.

19. The apparatus of claim 16, wherein a certain one of the responses to the interview questions that is provided to the server prompt a different one of the questions being delivered to solicit additional information about the particular architectural design.

20. The apparatus of claim 16, wherein the output presentation is rendered in a web-based format to an endpoint associated with providing the responses to the interview questions.
